(19) United States
(12) Patent Application Publication
(10) Pub. No.: US 2016/0150040 A1
(43) Pub. Date: May 26, 2016

(54) VIRTUAL DEVICE PROXY

(71) Applicant: AT&T Intellectual Property I, L.P., Atlanta, GA (US)

(72) Inventors: James W. Fan, San Ramon, CA (US); Jeffrey A. Aaron, Atlanta, GA (US); Venson Shaw, Kirkland, WA (US)

(21) Appl. No.: 14/551,524

(22) Filed: Nov. 24, 2014

(51) Int. Cl. H04L 29/08

(52) U.S. Cl. CPC H04L 67/28; H04L 67/14; H04L 67/10

(57) ABSTRACT

Utilizing a virtual proxy system to emulate a portion of a communication is presented herein. A method can include receiving status information corresponding to a communication session of a communication device; based on the status information, determining, utilizing a rule representing a condition corresponding to the communication session, an action to be performed with respect to an emulation of a portion of the communication session; and sending an instruction representing the action directed to a proxy device for performance of the emulation. In an example, the action can include translating the portion of the communication session to a text message, and sending, via the proxy device, the text message directed to the communication device. In another example, the action can include generating a proxy communication corresponding to the portion of the communication session, and sending, via the proxy device, the proxy communication to a target communication device.

### TECHNICAL FIELD

The subject disclosure generally relates to embodiments for a virtual device proxy.

### BACKGROUND

Communication service is degraded during network conditions associated with poor wireless coverage, reduced communication bandwidth, etc. Further, such service is degraded during user equipment (UE) conditions associated with low device battery power, reduced device processing, etc. In this regard, conventional communication network technologies do not mitigate service interruptions during degraded network and/or UE conditions. Consequently, conventional communication network technologies have had some drawbacks, some of which may be noted with reference to the various embodiments described herein below.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a virtual device proxy environment, in accordance with various embodiments;

FIG. 2 illustrates a block diagram of a virtual proxy system, in accordance with various embodiments;

FIG. 3 illustrates a block diagram of a virtual device proxy environment including a virtual device layer, in accordance with various embodiments;

FIG. 4 illustrates a block diagram of a virtual device proxy, in accordance with various embodiments;

FIG. 5 illustrates a block diagram of another virtual device proxy, in accordance with various embodiments;

FIGS. 6-10 illustrate flowcharts of methods associated with a virtual device proxy environment, in accordance with various embodiments;

FIG. 11 illustrates a block diagram of a network environment, in accordance various embodiments; and

FIG. 12 is a block diagram representing an illustrative non-limiting computing system or operating environment in which one or more aspects of various embodiments described herein can be implemented.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

Conventional communication network technologies have had some drawbacks with respect to mitigating service interruptions during degraded network and/or UE conditions—dropping, terminating, etc. active communications during such conditions. Various embodiments disclosed herein can improve communication service subscriber experiences by utilizing a virtual proxy system to emulate portion(s) of an active communication in response to detection of degraded network and/or device condition(s).

For example, a method can include receiving, monitoring, etc., by a system comprising a processor, e.g., by a virtual proxy system, status information corresponding to a communication session, e.g., a conference call, a video conference, a voice call, a text messaging session, an instant messaging session, a social networking communication, a machine-to-machine (M2M) communication, a gaming communication, etc. of a communication device, e.g., a wireless communication device, a smartphone, a laptop device, a tablet device, a television device, a vehicle device, a home security system device, a gaming console device, etc. Such status information can represent, for example, a state of the communication device, e.g., a power state of a battery, a power source, etc. of the communication device, a processing state corresponding to an amount of processing, available processing, etc. that can be performed by the communication device, a quality, e.g., signal-to-noise ratio (SNR), etc. of a signal determined to have been received by the communication device, a memory capacity of the communication device, a quality, e.g., SNR, etc. of a signal determined to have been received by a network device, e.g., access point (AP), a gateway (GW), etc. corresponding to the communication session, an amount of communication bandwidth, available communication bandwidth, etc. corresponding to the network device, etc.

Further, the method can include determining, by the system based on the status information—utilizing a defined rule, policy, constraint, etc.—an action to be performed with respect to an emulation of a portion of the communication session. In this regard, the rule can represent a condition for performance of the action, e.g., the rule specifying performance of the action in response to wireless signal condition(s), network device condition(s), communication device condition(s), service and/or task condition(s), etc., being determined to be degraded, e.g., in response to determining that: an amount of battery power that has been specified for a communication device, a service, a task, a set of service(s), a set of task(s), a combination of service(s), and/or a combination of task(s) is below a defined minimum amount of battery power for the communication device, the service, the task, the set of service(s), the set of task(s), the combination of service(s), and/or the combination of task(s); a processing capability that has been specified for the communication device, the service, the task, the set of service(s), the set of task(s), the combination of service(s), and/or the combination of task(s) is below a defined minimum amount of available processing power for the communication device, the service, the task, the set of service(s), the set of task(s), the combination of service(s), and/or the combination of task(s); the quality of the signal that has been specified for the communication device, the service, the task, the set of service(s), the set of task(s), the combination of service(s), and/or the combination of task(s) is below a defined minimum level of signal quality; the memory capacity that has been specified for the communication device, the service, the task, the set of service(s), the set of task(s), the combination of service(s), and/or the combination of task(s) is below a defined minimum level of memory capacity, the quality of the signal received by the network device is below a defined minimum level of signal quality, the amount of communication bandwidth corresponding to the network device is below a defined minimum amount of available communication bandwidth of the network device, etc.

Furthermore, the method can include sending, by the system, an instruction, message, command, etc. directed to a proxy device, virtual proxy device, virtual device proxy, etc.—the instruction representing the action to be performed by the proxy device for emulation of the portion of the communication session. In one embodiment, the action can include assuming, emulating, etc. communication responsibilities of a communication device, UE, etc. affected by degraded wireless signal conditions(s), network device condition(s), communication device condition(s), etc., e.g., to prolong the communication session, “smooth out” a conversational issue during weak and/or noisy signal conditions, etc. For example, the method can include translating, converting, etc., by the system based on the instruction, the portion of the communication session to a “lighter weight”, less demanding, lower bandwidth, etc. communication, e.g., a text message, a digitized voice clip, a lower resolution and/or lower bit rate translation of a voice or video communication, a canned symbolic message, a preset phrase, e.g., from a catalog, data store, etc., and sending, by the system via the proxy device, the lighter weight communication, e.g., text message, etc. directed to the communication device, e.g., translating, converting, etc. a voice communication, a text communication, a video communication, etc. into a reduced text summary, and sending the reduced text summary to the communication device, e.g., to communicate a reduced, minimum, etc. amount of information to the communication device in response to a determination that the communication device has been operating under degraded operational condition(s), e.g., a poor wireless signal condition, a low battery condition, etc.

In another embodiment, the method can include generating, by the system based on the instruction, a proxy communication corresponding to the portion of the communication session, and sending, by the system via the proxy device, the proxy communication directed to a target communication device on behalf of the communication device, e.g., emulating operation of the communication device during a communication session corresponding to the communication device and the target communication device, e.g., in response to determining that the communication device has been disconnected from the communication session, disconnected from a corresponding communication network, etc. In this regard, the method can assume communication operations, responsibilities, etc. of the communication device and maintain the communication session with the target communication device, e.g., for a defined period of time until the communication device has re-connected to the communication session, corresponding communication network, etc. For example, the method can maintain the communication session by generating, by the system, synthesized voice message(s), text message(s), etc. directed to the target communication device, and sending such messages to the target communication device, e.g., while proactively attempting to re-connect the communication device to the communication session, communication network, etc.

In yet another embodiment, the method can include recording, by the system based on the instruction, the portion of the communication session in a storage medium of the system. For example, in response to determining that the communication device has been operating under degraded operational condition(s), e.g., a poor wireless signal condition, a low battery condition, etc., the method can store, record, etc. messages of the communication session, e.g., corresponding to the communication device, in a memory, storage device, data storage device, etc., e.g., for later retrieval, viewing, etc., e.g., by a subscriber of a communication service corresponding to the communication session.

In an embodiment, the method can include receiving a message, a command, etc. including a request from the subscriber, and determining, by the system based on the message, a requested action to be performed with respect to the portion of the communication session. Further, the method can include sending, by the system, information representing the requested action directed to the proxy device for performance of the requested action. In this regard, the message can include a request to record portion(s) of a communication session directed to the communication device for a predetermined period of time, e.g., during a time that the subscriber will not be able to participate in the communication session. In one or more embodiments, when the subscriber has rejoined the communication session, e.g., during an on-going communication session, the subscriber can be provided an option to concurrently review the recorded portion(s) of the session, e.g., utilizing a fast speed mode that plays back speech of the recorded portion(s) at an accelerated rate, utilizing a conversion mode that converts the speech to text, etc.

In one embodiment, a system comprising a processor, e.g., a virtual proxy system can include a monitor component, a decision component, and an action component. The monitor component can be configured to determine status information associated with a communication session, e.g., a conference call, a video conference, a teleconference, a voice call, a text messaging session, an instant messaging session, a social networking communication, an M2M communication, a gaming communication, etc. corresponding to a communication device, e.g., a wireless communication device, a smartphone, a laptop device, a tablet device, a television device, a vehicle device, a home security system device, a gaming console device, etc.

The status information can represent a state of the communication device and/or a state of a network device, e.g., AP, GW, etc. corresponding to the communication session, e.g., representing a power state of a battery of the communication device, a processing state of the communication device, a quality of a signal that has been received by the communication device, a memory capacity of the communication device, a quality of a signal that has been received by the network device, an amount of communication bandwidth corresponding to the network device, etc.

The decision component can determine, based on the status information—using a defined policy with respect to a condition associated with the communication session, an action to be performed, e.g., via a proxy device, a virtual proxy device, a virtual device proxy, etc. with respect to an emulation of a portion of the communication session. In one or more embodiments, the defined policy can specify performance of the action, e.g., by the proxy device, in response to a state of, e.g., a communication device, a network device, a wireless signal, a service, a task, etc. satisfying the condition, e.g., in response to a determination that power state of the battery of the communication device is below a defined minimum level of battery power, the processing state of the communication device is below a defined minimum level of processing capability, the quality of the signal that has been received by the communication device is below a defined minimum level of signal quality, the memory capacity of the communication device is below a defined minimum level of memory capacity, the quality of the signal that has been received by the network device is below a defined minimum signal quality, the amount of communication bandwidth corresponding to the network device is below a defined minimum amount of available communication bandwidth of the network device, etc.

In other embodiments, one or more defined policies can also take into account a state of a current, particular, etc. service and/or task, a state of a current, particular, etc. set of services and/or tasks, and/or state(s) of combinations of services and tasks, e.g. specifying performance of the action in response to service and/or task conditions being determined to satisfy a defined threshold, condition, etc., e.g., being degraded, etc.

The action component can send instruction information representing the action directed to a proxy device, virtual proxy device, virtual device proxy, etc. for performance of the emulation of the portion of the communication session. In an embodiment, the action can include translation, conversion, etc., of the portion of the communication session, e.g., a voice communication, a text communication, a video communication, etc. to a text message, e.g., in response to a determination that the communication device has been operating under degraded operational condition(s), e.g., the power state of the battery of the communication device is below the defined minimum level of battery power, etc. In this regard, the translation, etc. of the portion of the communication to a text message is an example of replacing a “heavyweight” communication with a “lighter weight” communication, e.g., text. For example, “heavy”, heavy weight, etc. refers to a more demanding or higher bandwidth communication versus a less demanding or lower bandwidth communication referenced as a “light”, lighter weight, etc. communication. In other examples, other types of “lighter weight” or less demanding communication substitutions can be utilized, e.g., such as digitized voice clips, lower resolution and/or lower bit rate translations of voice and/or video communications, canned symbolic messages of any sort, preset phrases from a catalog, etc.

In another embodiment, the action can include generation of a proxy communication, e.g., synthesized voice message, text message, etc. corresponding to the portion of the communication session with respect to emulation of an operation of the communication device during a communication session corresponding to the communication device and a target communication device, e.g., in response to the determination that the communication device has been operating under degraded operational condition(s), e.g., the communication device has been disconnected from the communication session, disconnected from a corresponding communication network, etc.

In yet another embodiment, the action can include storage of the portion of the communication in a storage device, medium, etc. of the virtual proxy system, e.g., in response to the determination that the communication device has been operating under degraded operational condition(s). In this regard, the portion of the communication can be made available for future retrieval by a subscriber of a communication service corresponding to the communication session, e.g., for concurrent review during an on-going communication (see above). For example, the subscriber can review the portion of the communication that has been recorded utilizing a fast speed mode that plays back speech of the recorded portion(s) at an accelerated rate, utilizing a conversion mode that has converted the speech to text, etc.

One embodiment can include a computer-readable storage medium having stored thereon computer executable instructions that, in response to execution, cause a computing device including a processor to perform operations, the operations comprising: determining status information, e.g., a device state of a communication device, a network device, etc. corresponding to a communication associated with a communication device; based on the status information, determining, using a defined set of rules with respect to a condition corresponding to the communication, an action to be performed with respect to an emulation of at least a portion of the communication; and sending proxy information directed to a proxy device for performance of the emulation of at least the portion of the communication.

In another embodiment, the operations can include generating, based on at least the portion of the communication, a message, e.g., text message, synthesized voice message, etc., and sending, via the proxy device, the message directed to the communication device, directed to a target communication device on behalf of the communication device, etc.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. In yet another example, a component can be an apparatus that provides specific functionality through electronic components without mechanical parts; the electronic components can include one or more processors therein to execute software and/or firmware that confer(s), at least in part, the functionality of the electronic components.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, the systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, magnetic storage devices, e.g., hard disk; floppy disk; magnetic strip(s); optical disk (e.g., compact disk (CD), digital video disc (DVD), Blu-ray Disc (BD)); smart card(s); and flash memory device(s) (e.g., card, stick, key drive); and/or a virtual device that emulates a storage device and/or any of the above computer-readable media.

In accordance with various embodiments, processor(s) can be utilized in supporting a virtualized computing environment, virtualized device, etc. The virtualized computing environment can support virtual machine(s) representing computer(s), server(s), or other computing device(s). In such virtualized machine(s), component(s) such as processor(s) and/or a storage device(s) may be virtualized or logically represented. Further, the processor(s) can include distributed processing devices, or parallel processing devices, in a single machine, device, etc., or across multiple machines, devices, etc. Furthermore, the processor(s) can include a state machine, an application specific integrated circuit (ASIC), or a programmable gate array (PGA), e.g., field PGA (FPGA). In this regard, when the processor(s) execute instruction(s) to perform “operations”, the processor(s) can perform the operations directly, and/or facilitate, direct, or cooperate with other device(s) and/or component(s) to perform the operations.

In accordance with various aspects of the subject specification, artificial intelligence based systems, components, etc. can employ classifier(s) that are explicitly trained, e.g., via a generic training data, as well as implicitly trained, e.g., via observing characteristics of communication equipment, e.g., a gateway, a wireless communication device, etc., by receiving reports from such communication equipment, by receiving operator preferences, by receiving historical information, by receiving extrinsic information, etc. For example, support vector machines can be configured via a learning or training phase within a classifier constructor and feature selection module. Thus, the classifier(s) can be used by an artificial intelligence system to automatically learn and perform a number of functions, e.g., performed by virtual proxy system 110 (see below), including but not limited to determining status information associated with a communication session corresponding to a communication device, and determining, based on the status information using a defined policy with respect to a condition associated with the communication session, an action to be performed with respect to an emulation of a portion of the communication session.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to infer an action that a user desires to be automatically performed. In the case of communication systems, for example, attributes can be information received from access points, servers, components of a wireless communication network, etc., and the classes can be categories or areas of interest (e.g., levels of priorities). A support vector machine is an example of a classifier that can be employed. The support vector machine operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

For example, the classifier(s) can be used by the artificial intelligence system, e.g., virtual proxy system 110 (see below), to automatically determine, via monitor component 210 (see below), status information associated with a communication session corresponding to a communication device. Further, the classifier(s) can be used by the artificial intelligence system to automatically determine, via decision component 220 (see below) based on the status information using a defined policy with respect to a condition associated with the communication session, an action to be performed with respect to an emulation of a portion of the communication session. Furthermore, the artificial intelligence system can automatically send, via action component 230 (see below), instruction information representing the action directed to a proxy device for performance of the emulation of the portion of the communication session.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

As utilized herein, the terms “logic,” “logical,” “logically,” and the like are intended to refer to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

Aspects, features, and/or advantages of the disclosed subject matter can be exploited in substantially any wired telecommunication technology and/or any wireless telecommunication or radio technology, e.g., Institute of Electrical and Electronics Engineers (IEEE) 802.XX technology, e.g., Wi-Fi, Bluetooth, etc; worldwide interoperability for microwave access (WiMAX); enhanced general packet radio service (GPRS); third generation partnership project (3GPP) long term evolution (LTE); third generation partnership project 2 (3GPP2); ultra mobile broadband (UMB); 3GPP universal mobile telecommunication system (UMTS); high speed packet access (HSPA); high speed downlink packet access (HSDPA); high speed uplink packet access (HSUPA); LTE advanced (LTE-A), global system for mobile communication (GSM), near field communication (NFC), Wibree, Wi-Fi Direct, etc.

Further, selections of a radio technology, or radio access technology, can include second generation (2G), third generation (3G), fourth generation (4G), etc. evolution of the radio access technology; however, such selections are not intended as a limitation of the disclosed subject matter and related aspects thereof. Further, aspects, features, and/or advantages of the disclosed subject matter can be exploited in disparate electromagnetic frequency bands. Moreover, terms like “user equipment” (UE), “mobile station,” “mobile subscriber station,” “access terminal,” “terminal”, “handset,” “appliance,” “machine,” “wireless communication device,” “cellular phone,” “personal digital assistant,” “smartphone,” “wireless device”, and similar terminology refer to a wired and/or wireless device, or wired and/or wireless communication device, which is at least one of (1) utilized by a subscriber of a wired and/or wireless service, communication service, etc. to receive and/or convey data associated with voice, video, sound, and/or substantially any data-stream or signaling-stream; or (2) utilized by a subscriber of a voice over IP (VoIP) service that delivers voice communications over IP networks such as the Internet or other packet-switched networks. Further, the foregoing terms are utilized interchangeably in the subject specification and related drawings.

A communication network, e.g., corresponding to a virtual device proxy environment (see e.g., 100, 300, etc.), for systems, methods, and/or apparatus disclosed herein can include any suitable mobile and/or wireline-based circuit-switched communication network including a global systems for mobile communication (GSM) network, a time division multiple access (TDMA) network, a code division multiple access (CDMA) network, such as IS-95 and subsequent iterations of CDMA technology, an integrated digital enhanced network (iDEN) network, a public switched telephone network (PSTN), etc. Further, examples of the communication network can include any suitable data packet-switched or combination data packet/circuit-switched communication network, wired or wireless IP network such as a VoLTE network, a VoIP network, an IP data network, a universal mobile telecommunication system (UMTS) network, a general packet radio service (GPRS) network, or other communication networks that provide streaming data communication over IP and/or integrated voice and data communication over combination data packet/circuit-switched technologies.

Similarly, one of ordinary skill in the art will appreciate that a communication device, UE, etc. (see e.g., 102, 104, 106, etc.) for systems, methods, and/or apparatus disclosed herein can include a wireless device, a wired device, e.g., physically coupled to the communication network, a mobile device, a mobile phone, a 4G, etc. cellular communication device, a PSTN phone, a cellular communication device, a cellular phone, a satellite communication device, a satellite phone, a VoIP phone, Wi-Fi phone, a dual-mode cellular/Wi-Fi phone, a combination cellular/VoIP/Wi-Fi/WiMAX phone, a smartphone, a laptop device, a tablet device, a television device, a vehicle device, a home security system device, a portable computer, or any suitable combination thereof. Specific examples of a wireless system can include, but are not limited to, a cellular device, such as a GSM, TDMA, CDMA, IS-95 and/or iDEN phone, a cellular/Wi-Fi device, such as a dual-mode GSM, TDMA, IS-95 and/or iDEN/VoIP phones, UMTS phones, UMTS VoIP phones, or like devices or combinations thereof.

To provide support for virtual proxy system 110, the communication network can include a gateway routing component (not shown) that can include any suitable component that can perform centralized routing within a mobile, satellite, or similar network (but optionally need not include components that route strictly within a PSTN network), routing between communication networks, between networks of varying architecture (e.g., between PSTN, GSM, UMTS), Enterprise VoIP, the Internet, or combinations thereof), and the like. Specific examples of a gateway routing component can include, but are not limited to, a gateway mobile switching center (GMSC), a gateway general packet radio service (GPRS) support node (GGSN), a session border control (SBC) device, or like devices. Additionally, a data storage component of such system(s), device(s), etc. can include any suitable device, process, and/or combination device that can store digital and/or switched information (e.g., server, data store component, or the like).

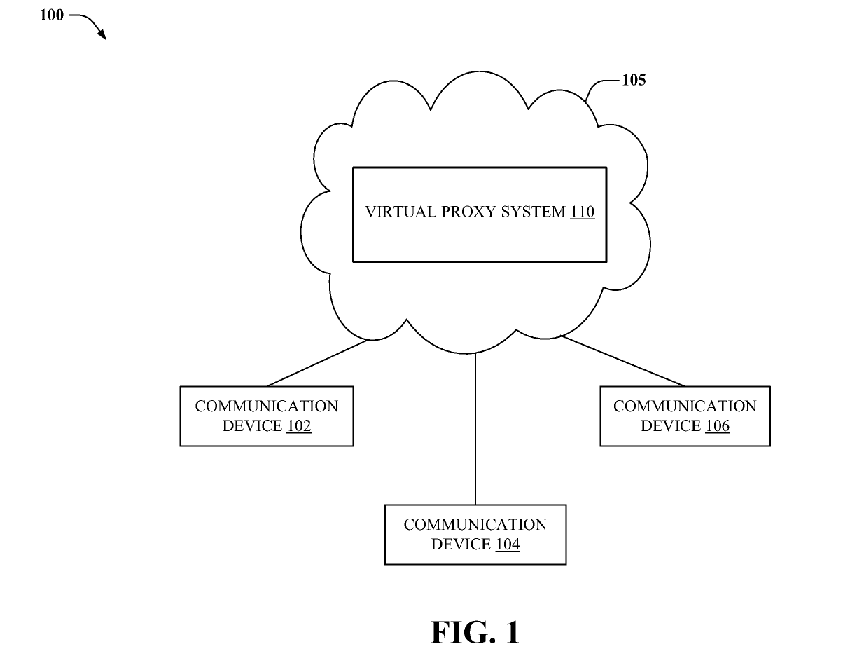

Conventional communication network technologies have had some drawbacks with respect to mitigating service interruptions during degraded UE and/or network conditions. On the other hand, various embodiments disclosed herein emulate portion(s) of a communication session in response to detection of degraded network and/or device condition(s). In this regard, and now referring to FIGS. 1 to 5, virtual proxy system 110 provides a virtual device proxy that can assume, emulate, etc. communication responsibilities of a communication device, UE, etc. affected by adverse operating conditions.

Now referring to FIGS. 1-4, virtual device proxy environment 100, virtual proxy system 110, virtual device proxy environment 300, and virtual device proxy 320 are illustrated, respectively, in accordance with various embodiments. In various aspects, virtual proxy system 110 can be coupled to a communication device (see e.g., 102, 104, 106, etc.), e.g., a wireless communication device, a smartphone, a laptop device, a tablet device, a television device, a vehicle device, a home security system device, a gaming console device, UE, etc. via a wired and/or wireless interface (not shown). The wireless interface can be an over-the-air wireless link comprising a downlink (DL) and an uplink (UL) (both not shown) that can utilize a predetermined band of radio frequency (RF) spectrum associated with, e.g., cellular, LTE, LTE-A, GSM, 3GPP UMTS, Wi-Fi, WiMax, wireless local area networks (WLAN), Femto, etc. Accordingly, the communication device can be associated with such predetermined RF spectrum.

Service provider network 105 can include software and/or hardware configured to provide connectivity between virtual proxy system 110 and the communication device. In this regard, virtual device proxy environment 100 and virtual device proxy environment 300 can include one or more: macro, Femto, or pico access points (APs) (not shown); base stations (BS) (not shown); landline networks (e.g., optical landline networks, electrical landline networks) (not shown) communicatively coupled between virtual proxy system 110 and the communication device. In various embodiments, virtual proxy system 110 can communicate via any number of various types of wireless technologies including, but not limited to, cellular, Wi-Fi, WiMax, wireless local area networks (WLAN), Femto, etc. In corresponding embodiments, service provider network 105 can provide cellular, Wi-Fi, WiMAX, WLAN, and/or other technologies for facilitating such communication. Further, service provider network 105 can include one or more of the Internet (or another communication network (e.g., IP-based network)), or a digital subscriber line (DSL)-type or broadband network facilitated by Ethernet or other technology. In this regard, service provider network 105 can include a cloud-based, centralized, communication platform, Internet platform, wide area network, etc., and component(s), portion(s), etc. of virtual proxy system 110, e.g., a virtual device proxy (see below), can be implemented within the cloud-based, centralized, communication platform.

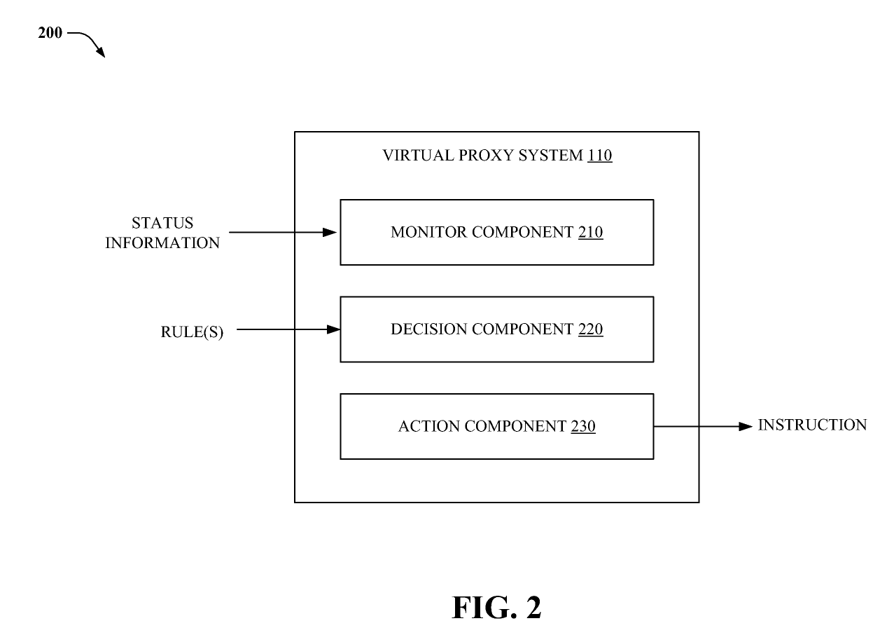

As illustrated by FIG. 2, virtual proxy system 110 can include monitor component 210 that can determine, receive, monitor, etc. status information associated with a communication session, e.g., a conference call, a video conference, a teleconference, a voice call, a text messaging session, an instant messaging session, a social networking communication, an M2M communication, a gaming communication, etc. corresponding to the communication device. The status information can represent a state of the communication device and/or a state of a network device, e.g., AP, GW, etc. corresponding to the communication session, e.g., representing a power state of a battery of the communication device, a processing state of the communication device, a quality of a signal that has been received by the communication device, a memory capacity of the communication device, a quality of a signal that has been received by the network device, an amount of communication bandwidth corresponding to the network device, etc.

Virtual proxy system 110 can further include decision component 220, which can determine, based on the status information, using a defined policy, rule(s), constraint(s), etc. with respect to a condition associated with the communication session, an action to be performed, e.g., via a proxy device, a virtual proxy device, a virtual device proxy (e.g. 320, 330, 340 of a virtual device platform, e.g. virtual device layer 310), etc. with respect to an emulation of a portion of the communication session. In one or more embodiments, the defined policy, etc. can specify performance of the action, e.g., by the proxy device, etc. in response to the state of the communication device and/or the state of the network device satisfying the condition, e.g., in response to a determination that the power state of the battery of the communication device is below a defined minimum level of battery power, the processing state of the communication device is below a defined minimum level of processing capability, the quality of the signal that has been received by the communication device is below a defined minimum level of signal quality, the memory capacity of the communication device is below a defined minimum level of memory capacity, the quality of the signal that has been received by the network device is below a defined minimum signal quality, the amount of communication bandwidth corresponding to the network device is below a defined minimum amount of available communication bandwidth of the network device, etc. In other embodiments, the defined policy, etc. can specify performance of the action, e.g., by the proxy device, etc. in response to a state of a service, a task, a set of service(s), a set of task(s), a combination of service(s) and/or task(s), etc. being determined to satisfy a defined condition.

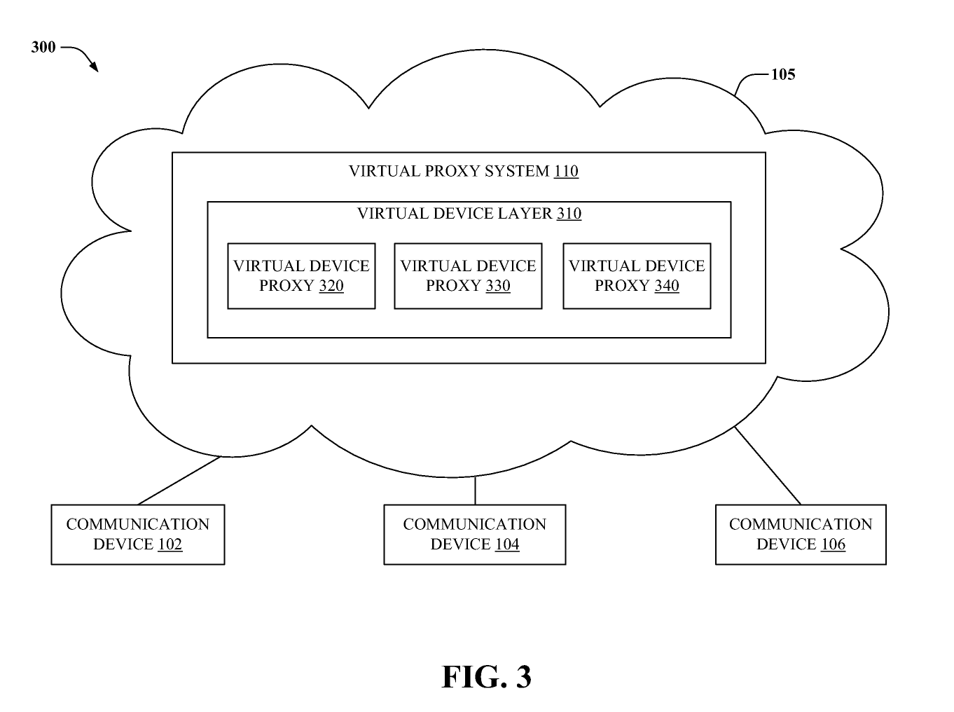

Virtual proxy system 110 can further include action component 230, which can send an instruction, instruction information, etc. representing the action directed to the virtual device proxy (e.g. 320, 330, 340), proxy device, virtual proxy device, etc. for performance of the emulation of the portion of the communication session. In this regard, the virtual device proxy can assume, emulate, etc. communication responsibilities of the communication device to maintain and/or prolong the communication session, “smooth out” a conversational issue during weak and/or noisy signal conditions, etc. under degraded wireless signal condition(s), network device condition(s), communication device condition(s), etc. As illustrated by FIG. 3, one or more virtual device proxies can be included within virtual device layer 310 to perform various operations to maintain communication sessions, active communication sessions, etc. for respective communication devices (e.g. 102, 104, 106). It should be appreciated that the one or more virtual device proxies can perform any number of operations with respect to virtual device proxy 320, 330, 340, etc. described below.

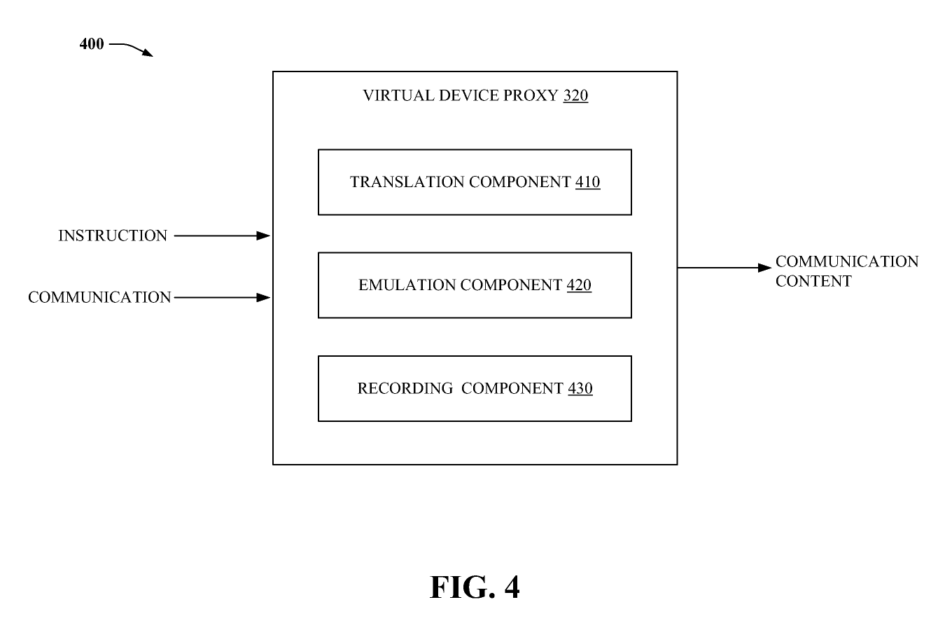

In one or more embodiments, and now referring to FIG. 4, a virtual device proxy, e.g., virtual device proxy 320, can include translation component 410, emulation component 420, and recording component 430. Translation component 410 can translate, convert, etc., based on an instruction received from action component 230, a portion of a communication and/or a communication session, e.g., a voice communication, a text communication, a video communication, etc. that has been directed to a communication device, e.g., 102, to a lighter weight, less demanding, lower bandwidth, etc. communication, e.g., a text message, a reduced text summary, a digitized voice clip, a lower resolution and/or lower bit rate translation of a voice or video communication, a canned symbolic message, a preset phrase, e.g., from a catalog, data store, etc. comprising a set of preset phrases, etc., e.g., in response to a determination, via decision component 220, that the communication device has been operating under degraded operational condition(s), e.g., a power state of a battery of the communication device has been determined to be below a defined minimum level of battery power, etc. In this regard, virtual device proxy 320 can intercept the portion of the communication session, convert the portion into a reduced format, e.g., reduced text summary, and send the text message, reduced text summary, etc. to the communication device, which can receive the text message utilizing reduced power.

Emulation component 420 can emulate, based on the instruction, operation of a communication device, e.g., 102, during a communication session between the communication device and a target communication device, e.g., 104, 106, etc., e.g., in response to a determination, via decision component 220, that the communication device has been operating under degraded operational condition(s), e.g., the communication device has been disconnected from the communication session, disconnected from a corresponding communication network, etc. In this regard, virtual device proxy 320 can generate a proxy communication, e.g., synthesized voice message, text message, etc. corresponding to the communication session, and send the proxy communication to the target communication device on behalf of the communication device, e.g., assuming communication operations, responsibilities, etc. of the communication device to maintain the communication session with the target communication device, e.g., for a defined period of time, e.g., until the communication device has re-connected to the communication session and/or corresponding communication network, etc.

For example, emulation component 420 can generate and send a message, synthesized voice message, text message, etc. to the target communication device indicating that the communication device is temporarily out of service. In an embodiment, virtual proxy system 110 can proactively attempt to re-connect the communication device to the communication session, communication network, etc. while emulation component 420 has been emulating operation of the communication device. In this regard, in another embodiment, emulation component 420 can maintain a conference call, video conference, teleconference, etc. between the communication device and the target communication device while the communication device is out of service, and virtual proxy system 110 can attempt to re-connect the communication device to the conference call, etc.

Recording component 430 can record, store, etc., based on the instruction, portion(s), message(s), etc. of the communication session in a memory, storage medium, etc. (not shown) of virtual proxy system 110, e.g., in response to a determination the communication device has been operating under degraded operational condition(s). In this regard, the portion of the communication can be made available for future retrieval by a subscriber of a communication service corresponding to the communication session. In an embodiment, when the subscriber has rejoined, e.g., an on-going communication session, e.g., when the device operates under non-degraded operational condition(s), recording component 430 can provide the subscriber an option to concurrently review recorded portion(s) of the session, e.g., utilizing a fast speed mode that plays back speech of the recorded portion(s) at an accelerated rate, utilizing a conversion mode that converts the speech to text, etc.

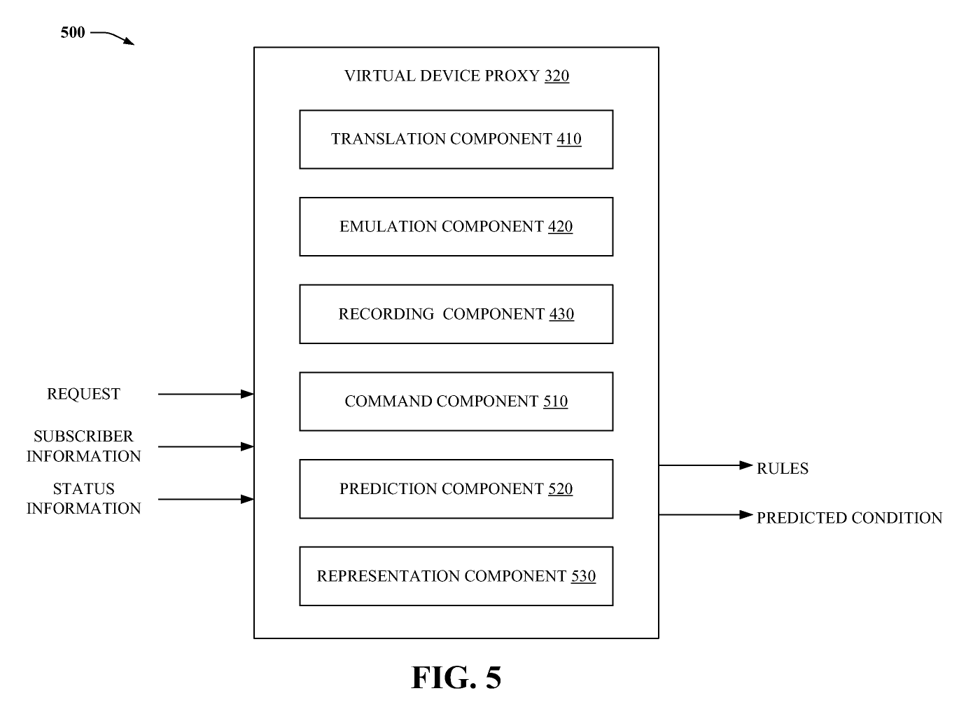

In another embodiment illustrated by FIG. 5, a virtual device proxy, e.g., virtual device proxy 320, can include command component 510, prediction component 520, and representation component 530. Command component 510 can receive request(s) from the subscriber to establish, initiate, etc. virtual device proxy operations, e.g., of virtual device proxy 320 described herein, for example, in response to a purchase of the communication device, in response to an initialization of service(s) of the communication device, etc. In another example, command component 510 can receive the request(s) from the subscriber to initiate the virtual device proxy operations, e.g., to record portion(s) of a conference call, teleconference, video conference, etc. in response to the subscriber anticipating he/she will be offline, “stepping out”, etc. from the conference call, etc.—such portion(s) made available for future retrieval by the subscriber.

Prediction component 520 can predict, anticipate, determine, etc. the policy, rule(s), constraint(s), etc. utilized by decision component 220 based on status information received by virtual proxy system 110, e.g., based on a determined, e.g., location of the communication device, computational load of the communication device, number and type of applications executing on the communication device, current tasks being performed by the applications, power state of a power source, e.g., battery, of the communication device, communication bandwidth of a network device of the communication network, quality of a wireless signal corresponding to the communication device and/or the network device, etc.

In one embodiment, prediction component 520 can receive subscriber information referencing characteristic(s), e.g., an age, a hearing ability, a vision ability, etc. of the subscriber. In this regard, prediction component 520 can determine the policy, rule(s), constraint(s), etc. utilized by decision component 220 based on the subscriber information—customizing virtual device proxy operations, e.g., of virtual proxy device 320 described herein, based on an ability of the subscriber to utilize assumed, emulated, etc. communications generated via virtual proxy device 320, e.g., based on the age, hearing ability, vision ability etc. of the subscriber.

In another embodiment, prediction component 520 can determine a trend of discharge of battery power, a trend in decrease of SNR, a trend in decrease in communication bandwidth, etc. and anticipate, predict, etc., based on the determined trend, an adverse operating condition of the communication device, network device, etc. Further, based on the anticipated, predicted, etc. operating condition, decision component 220 can assume, emulate, etc. communication responsibilities of a communication device, UE, etc. in anticipation of the adverse operating condition. In other embodiment(s), message(s) can optionally and/or conditionally be sent, e.g. based on policy rules, to communicating parties, e.g., to communication devices associated with a group communication, indicating that some particular change or action will, e.g., soon, be taken based upon a trend determined by prediction component 520.

Representation component 530 can receive, via command component 510, request(s) from the subscriber to deliver recorded content to the subscriber, e.g., in conjunction with defined policy rule(s), constraint(s), etc. In an embodiment, representation component 530 can convert previously recorded, stored, etc. communication content to text and/or other requested format(s), e.g., based on a request received from the subscriber and the defined policy rule(s), etc. For example, if the subscriber was not able to participate for a period of time during a conference call, and associated portions of the conference call were recorded, e.g., as video, text, audio, etc., the subscriber can utilize, leverage, etc. representation component 530 to quickly scan, review, etc. such recorded portions, e.g., after the subscriber has rejoined the conference call—enabling the subscriber to come up to speed with what he/she missed. In another embodiment, representation component 530 can convert recorded portions to text. In this regard, representation component 530 can enable the subscriber to obtain background information corresponding to a topic of a conversation, e.g., while the subscriber is participating in a communication, teleconference, etc. including the topic.

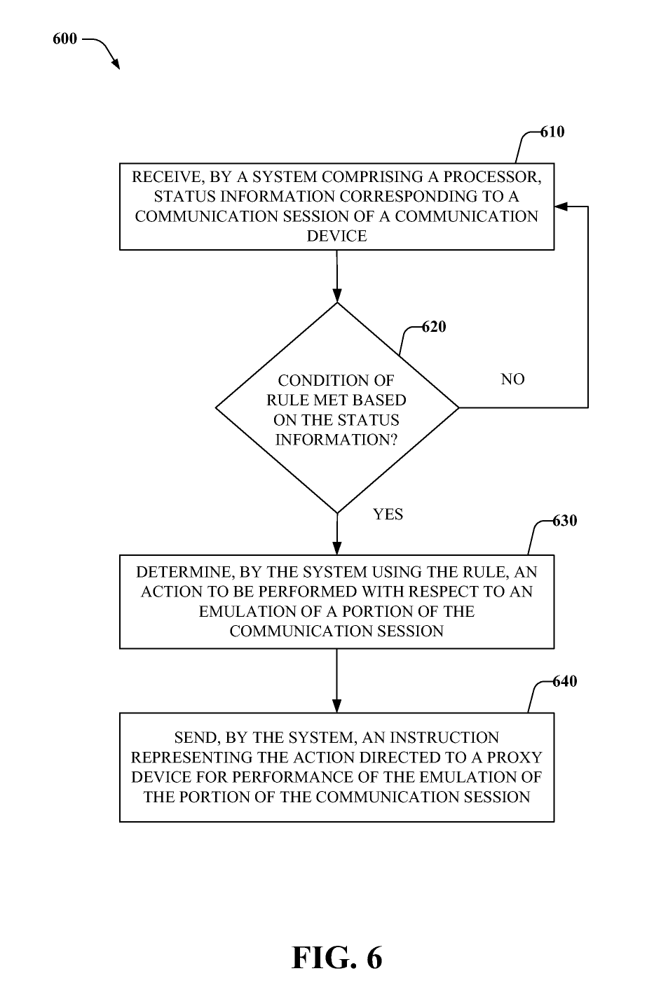

FIGS. 6-9 illustrate methodologies in accordance with the disclosed subject matter. For simplicity of explanation, the methodologies are depicted and described as a series of acts. It is to be understood and appreciated that various embodiments disclosed herein are not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIGS. 6-9, processes 600 to 900 performed by virtual proxy system 110 are illustrated, in accordance with various embodiments. In an embodiment illustrated by FIG. 6, at 610, status information corresponding to a communication session of a communication device can be received. In embodiment(s), the status information can represent, e.g., a state of the communication device, e.g., a power state of a battery, a power source, etc. of the communication device, a processing state corresponding to an amount of processing, available processing, etc. that can be performed by the communication device, a quality, e.g., SNR, etc. of a signal determined to have been received by the communication device, a memory capacity of the communication device, a quality, e.g., SNR, etc. of a signal determined to have been received by a network device, e.g., AP, GW, etc. corresponding to the communication session, an amount of communication bandwidth, available communication bandwidth, etc. corresponding to the network device, etc.

In other embodiment(s), the communication session can include a conference call, a video conference, a voice call, a text messaging session, an instant messaging session, a social networking communication, an M2M communication, a gaming communication, etc. Further, the communication device can include a wireless communication device, a smartphone, a laptop device, a tablet device, a television device, a vehicle device, a home security system device, a gaming console device, etc.

At 620, it can be determined, based on the status information, whether a condition of a rule—the rule specifying performance of an action in response to device and/or network conditions being determined to be degraded—has been met. In response to determining that the condition of the rule has been met, flow continues to 630, at which the action can be determined based on the rule—the action to be performed with respect to an emulation of a portion of the communication session; otherwise flow returns to 610. At 640, an instruction, message, etc. representing the action can be sent directed to a proxy device for performance of the emulation of the portion of the communication session.

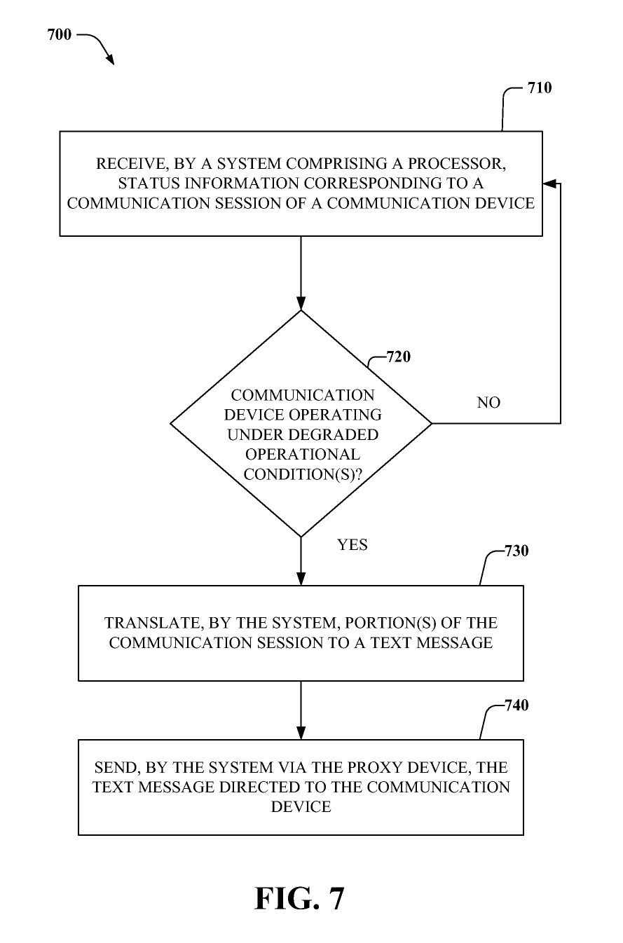

In an embodiment illustrated by FIG. 7, at 710, status information corresponding to a communication session of a communication device can be received. As described above, in embodiment(s), the status information can represent, e.g., a state of the communication device, e.g., a power state of a battery, a power source, etc. of the communication device, a processing state corresponding to an amount of processing, available processing, etc. that can be performed by the communication device, a quality, e.g., SNR, etc. of a signal determined to have been received by the communication device, a memory capacity of the communication device, a quality, e.g., SNR, etc. of a signal determined to have been received by a network device, e.g., AP, GW, etc. corresponding to the communication session, an amount of communication bandwidth, available communication bandwidth, etc. corresponding to the network device, etc.

In other embodiment(s), the communication session can include a conference call, a video conference, a voice call, a text messaging session, an instant messaging session, a social networking communication, an M2M communication, a gaming communication, etc. Further, the communication device can include a wireless communication device, a smartphone, a laptop device, a tablet device, a television device, a vehicle device, a home security system device, a gaming console device, etc.

At 720, it can be determined, e.g., based on the status information, whether the communication device has been operating under degraded operational conditions, e.g., low battery power, low processing power, poor signal condition(s), etc. In response to determining that the communication device has been operating under the degraded operational conditions, flow continues to 730, at which portion(s) of the communication session, e.g., a voice call, a video teleconference, etc. can be translated, converted, etc. to a text message; otherwise flow returns to 710. At 740, the text message can be sent, via a proxy device, directed to the communication device.

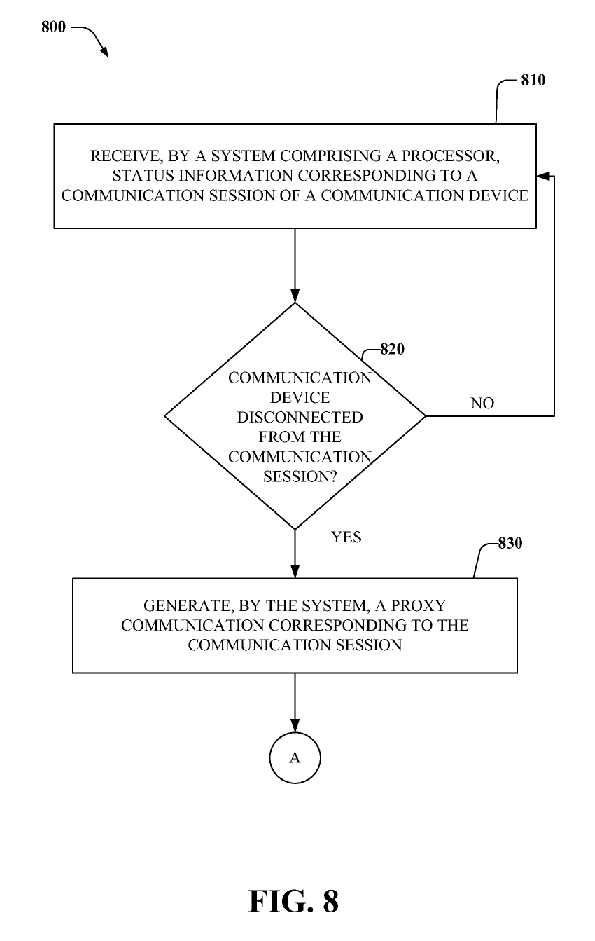

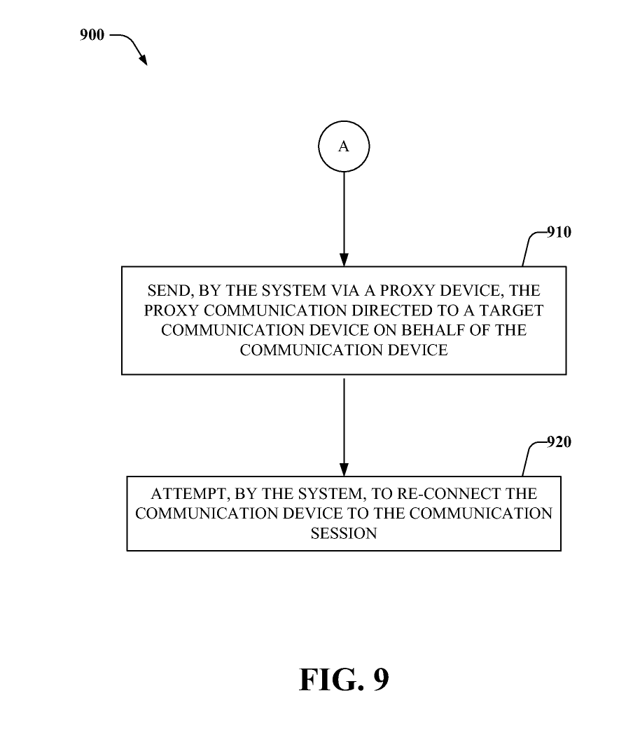

Referring now to embodiment(s) illustrated by FIGS. 8 and 9, status information corresponding to a communication session of a communication device can be received at 810. As described above, in embodiment(s), the status information can represent, e.g., a state of the communication device, e.g., a power state of a battery, a power source, etc. of the communication device, a processing state corresponding to an amount of processing, available processing, etc. that can be performed by the communication device, a quality, e.g., SNR, etc. of a signal determined to have been received by the communication device, a memory capacity of the communication device, a quality, e.g., SNR, etc. of a signal determined to have been received by a network device, e.g., AP, GW, etc. corresponding to the communication session, an amount of communication bandwidth, available communication bandwidth, etc. corresponding to the network device, etc.

In other embodiment(s), the communication session can include a conference call, a video conference, a voice call, a text messaging session, an instant messaging session, a social networking communication, an M2M communication, a gaming communication, etc. Further, the communication device can include a wireless communication device, a smartphone, a laptop device, a tablet device, a television device, a vehicle device, a home security system device, a gaming console device, etc.

At 820, it can be determined, based on the status information, whether the communication device has been disconnected from the communication session. In response to determining that the communication device has been disconnected from the communication session, flow continues to 830, at which a proxy communication corresponding to the communication session can be generated; otherwise flow returns to 810. In one or more embodiments, the proxy communication can include a synthesized voice message, a text message, etc.

Referring now to FIG. 9, flow continues to 910 from 830, at which the proxy communication can be sent, via a proxy device, directed to a target communication device on behalf of the communication device—the communication session conducted between at least the target communication device and the communication device. At 920, an attempt can be made to re-connect the communication device to the communication session, the target device, etc.

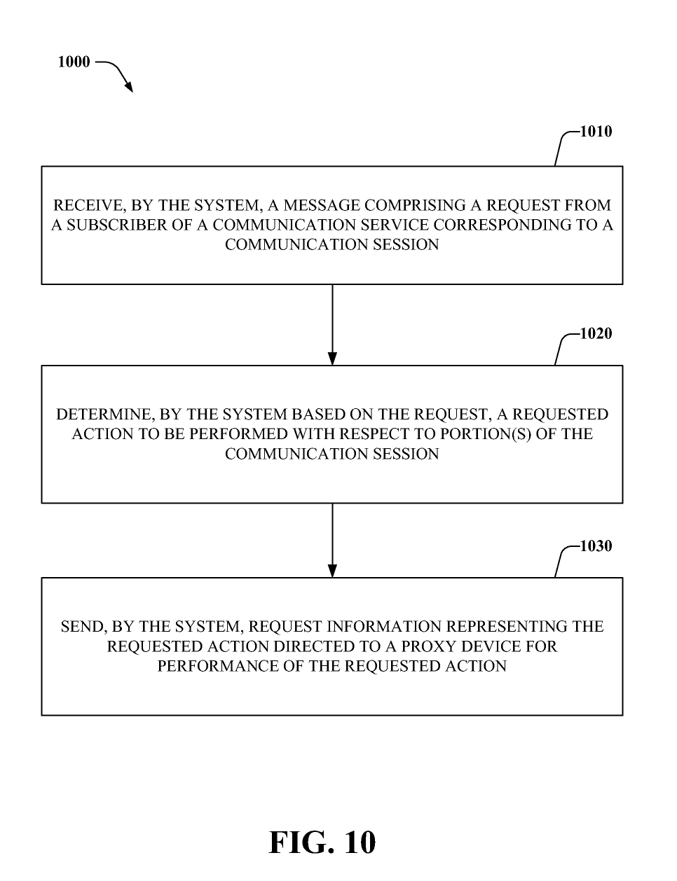

In embodiment(s) illustrated by FIG. 10, a message, instruction, etc. comprising a request from a subscriber of a communication service corresponding to a communication session can be received at 1010. As described above, the communication session can include a conference call, a video conference, a voice call, a text messaging session, an instant messaging session, a social networking communication, an M2M communication, a gaming communication, etc.

At 1020, a requested action to be performed with respect to portion(s) of the communication session can be determined based on the requested. In embodiment(s), the requested action can include recording portion(s) of a communication session directed to the communication device for a predetermined period of time, e.g., during a predetermined period of time that the subscriber has determined he/she will not be able to participate in the communication session. At 1030, request information representing the requested action can be sent directed to a proxy device for performance of the requested action.

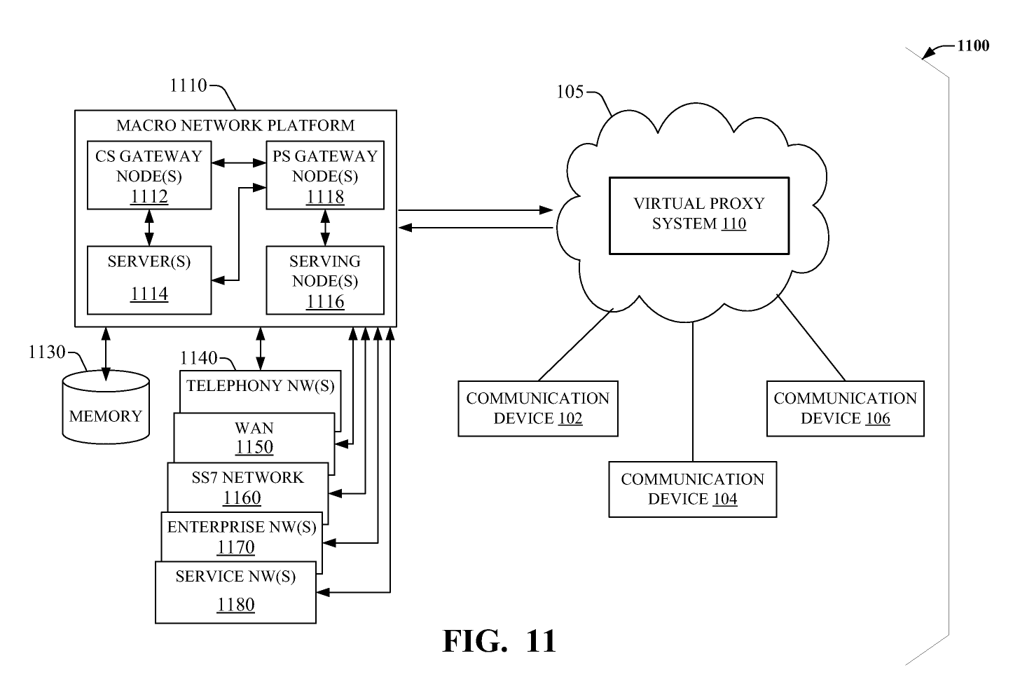

With respect to FIG. 11, a wireless communication environment 1100 including macro network platform 1110 is illustrated, in accordance with various embodiments. Macro network platform 1110 serves or facilitates communication with a communication device, e.g., 102, 104, 106, etc. via service provider network 105. Service provider network 105 can include base station(s), base transceiver station(s), access point(s), etc. and associated electronic circuitry and deployment site(s), in addition to a wireless radio link operated in accordance with the base station(s), etc. Accordingly, service provider network 105 can comprise various coverage cells, or wireless coverage areas. In addition, it should be appreciated that elements and/or components of virtual proxy system 110 can be located/included within one or more components/elements, e.g., hardware, software, etc., of wireless communication environment 1100, e.g., macro network platform 1110, service provider network 105, etc.

Generally, macro network platform 1110 includes components, e.g., nodes, GWs, interfaces, servers, platforms, etc. that facilitate both packet-switched (PS), e.g., IP, frame relay, asynchronous transfer mode (ATM), and circuit-switched (CS) traffic, e.g., voice and data, and control generation for networked wireless communication, e.g., via virtual proxy system 110. In various embodiments, macro network platform 1110 includes CS GW node(s) 1112 that can interface CS traffic received from legacy networks like telephony network(s) 1140, e.g., public switched telephone network (PSTN), public land mobile network (PLMN), Signaling System No. 7 (SS7) network 1160, etc. CS GW node(s) 1112 can authorize and authenticate traffic, e.g., voice, arising from such networks. Additionally, CS GW node(s) 1112 can access mobility or roaming data generated through SS7 network 1160; for instance, mobility data stored in a visitor location register (VLR), which can reside in memory 1130. Moreover, CS GW node(s) 1112 interfaces CS-based traffic and signaling with PS GW node(s) 1118. As an example, in a 3GPP UMTS network, PS GW node(s) 1118 can be embodied in GW GPRS support node(s) (GGSN).

As illustrated by FIG. 11, PS GW node(s) 1118 can receive and process CS-switched traffic and signaling via CS GW node(s) 1112. Further PS GW node(s) 1118 can authorize and authenticate PS-based data sessions with served, e.g., via service provider network 105, communication devices, e.g., 102, 104, 106, etc. Such data sessions can include traffic exchange with networks external to the macro network platform 1110, like wide area network(s) (WANs) 1150; enterprise networks (NWs) 1170, e.g., E911, service NW(s) 1180, e.g., an IP multimedia subsystem (IMS), etc. It should be appreciated that local area network(s) (LANs), which may be a part of enterprise NW(s) 1170, can also be interfaced with macro network platform 1110 through PS GW node(s) 1118. PS GW node(s) 1118 can generate packet data contexts when a data session is established. To that end, in an aspect, PS GW node(s) 1118 can include a tunnel interface, e.g., tunnel termination GW (TTG) in 3GPP UMTS network(s) (not shown), which can facilitate packetized communication with disparate wireless network(s), such as Wi-Fi networks. It should be further appreciated that the packetized communication can include multiple flows that can be generated through server(s) 1114. It is to be noted that in 3GPP UMTS network(s), PS GW node(s) 1118 (e.g., GGSN) and tunnel interface (e.g., TTG) comprise a packet data GW (PDG).

Macro network platform 1110 also includes serving node(s) 1116 that can convey the various packetized flows of information, or data streams, received through PS GW node(s) 1118. As an example, in a 3GPP UMTS network, serving node(s) can be embodied in serving GPRS support node(s) (SGSN).

As indicated above, server(s) 1114 in macro network platform 1110 can execute numerous applications, e.g., messaging, location services, wireless device management, etc. that can generate multiple disparate packetized data streams or flows; and can manage such flows, e.g., schedule, queue, format. Such application(s), for example can include add-on features to standard services provided by macro network platform 1110. Data streams can be conveyed to PS GW node(s) 1118 for authorization/authentication and initiation of a data session, and to serving node(s) 1116 for communication thereafter. Server(s) 1114 can also effect security, e.g., implement one or more firewalls, of macro network platform 1110 to ensure network's operation and data integrity in addition to authorization and authentication procedures that CS GW node(s) 1112 and PS GW node(s) 1118 can enact. Moreover, server(s) 1114 can provision services from external network(s), e.g., WAN 1150, or global positioning system (GPS) network(s), which can be a part of enterprise NW(s) 1180. It is to be noted that server(s) 1114 can include one or more processors configured to confer at least in part the functionality of macro network platform 1110. To that end, the one or more processors can execute code instructions stored in memory 1130, for example.

In wireless communication environment 1100, memory 1130 can store information related to operation of macro network platform 1110, e.g., related to operation of virtual proxy system 110. The information can include business data associated with subscribers; market plans and strategies, e.g., promotional campaigns, business partnerships, mobile devices served through macro network platform, etc.; service and privacy policies; end-user service logs for law enforcement; term(s) and/or condition(s) associated with wireless service(s) provided via service provider network 105; and so forth. Memory 1130 can also store information from at least one of telephony network(s) 1140, WAN 1150, SS7 network 1160, enterprise NW(s) 1170, or service NW(s) 1180.

In one or more embodiments, components of core network environment 1100 can provide communication services to the wireless device, e.g., 102, 104, 106, etc. via service provider network 105 utilizing an over-the-air wireless link (not shown). In this regard, service provider network 105 can include one or more: macro, Femto, or pico access points (APs) (not shown); base stations (BS) (not shown); landline networks (e.g., optical landline networks, electrical landline networks) (not shown) communicatively coupled between the communication device, e.g., 102, 104, 106, etc. and macro network platform 1310. Further, the over-the-air wireless link can comprise a downlink (DL) and an uplink (UL) (both not shown) that can utilize a predetermined band of radio frequency (RF) spectrum associated with any number of various types of wireless technologies including, but not limited to, cellular, LTE, LTE-A, GSM, 3GPP UMTS, Wi-Fi, WiMax, wireless local area networks (WLAN), Femto, etc.

Core network environment 1100, e.g., service provider network 105, etc. can include one or more of the Internet (or another communication network (e.g., IP-based network)), or a digital subscriber line (DSL)-type or broadband network facilitated by Ethernet or other technology. In various embodiments, core network environment 1100 can include hardware and/or software for allocating resources to the communication device, e.g., 102, 104, 106, etc., converting or enforcing protocols, establishing and/or providing levels of quality of service (QoS), providing applications or services, translating signals, and/or performing other desired functions to facilitate system interoperability and communication to/from the communication device, e.g., 102, 104, 106, etc.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” data storage,” “database,” and substantially any other information storage component relevant to operation and functionality of a component and/or process, refer to “memory components,” or entities embodied in a “memory,” or components comprising the memory. It will be appreciated that the memory components described herein can be either volatile memory or nonvolatile memory, or can include both volatile and nonvolatile memory.

By way of illustration, and not limitation, nonvolatile memory, for example, can be included in non-volatile memory 1222 (see below), disk storage 1224 (see below), and/or memory storage 1246 (see below). Further, nonvolatile memory can be included in read only memory (ROM), programmable ROM (PROM), electrically programmable ROM (EPROM), electrically erasable ROM (EEPROM), or flash memory. Volatile memory 1220 can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

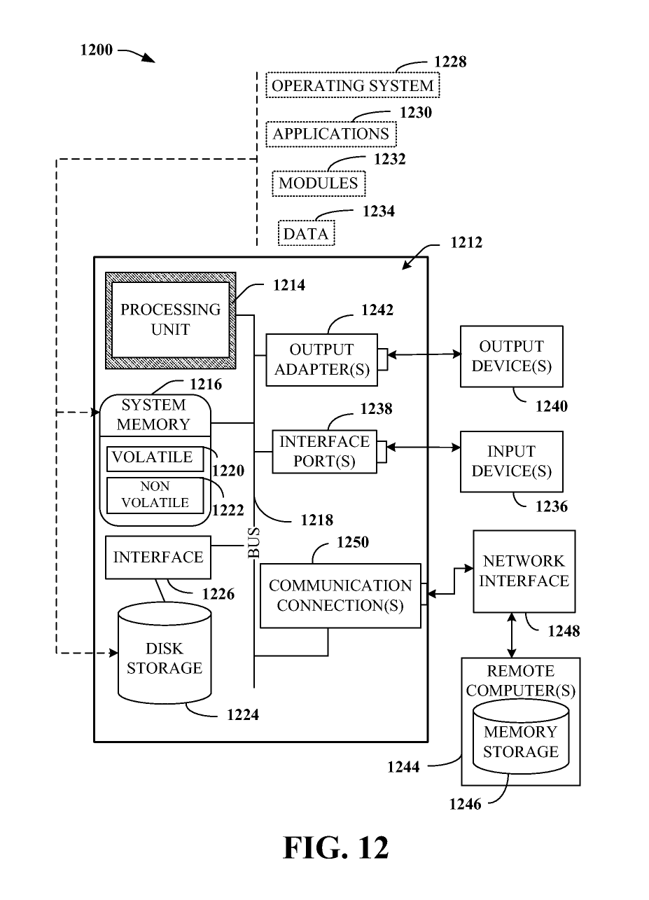

In order to provide a context for the various aspects of the disclosed subject matter, FIG. 12, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that various embodiments disclosed herein can be implemented in combination with other program modules. Generally, program modules include routines, programs, components, data structures, etc. that perform particular tasks and/or implement particular abstract data types.

Moreover, those skilled in the art will appreciate that the inventive systems can be practiced with other computer system configurations, including single-processor or multiprocessor computer systems, computing devices, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communication network; however, some if not all aspects of the subject disclosure can be practiced on stand-alone computers. In a distributed computing environment, program modules can be located in both local and remote memory storage devices.

With reference to FIG. 12, a block diagram of a computing system 1200 operable to execute the disclosed systems and methods is illustrated, in accordance with an embodiment. Computer 1212 includes a processing unit 1214, a system memory 1216, and a system bus 1218. System bus 1218 couples system components including, but not limited to, system memory 1216 to processing unit 1214. Processing unit 1214 can be any of various available processors. Dual microprocessors and other multiprocessor architectures also can be employed as processing unit 1214.

System bus 1218 can be any of several types of bus structure(s) including a memory bus or a memory controller, a peripheral bus or an external bus, and/or a local bus using any variety of available bus architectures including, but not limited to, industrial standard architecture (ISA), micro-channel architecture (MSA), extended ISA (EISA), intelligent drive electronics (IDE), VESA local bus (VLB), peripheral component interconnect (PCI), card bus, universal serial bus (USB), advanced graphics port (AGP), personal computer memory card international association bus (PCMCIA), Firewire (IEEE 1394), small computer systems interface (SCSI), and/or controller area network (CAN) bus used in vehicles.

System memory 1216 includes volatile memory 1220 and nonvolatile memory 1222. A basic input/output system (BIOS), containing routines to transfer information between elements within computer 1212, such as during start-up, can be stored in nonvolatile memory 1222. By way of illustration, and not limitation, nonvolatile memory 1222 can include ROM, PROM, EPROM, EEPROM, or flash memory. Volatile memory 1220 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1212 also includes removable/non-removable, volatile/non-volatile computer storage media. FIG. 12 illustrates, for example, disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to system bus 1218, a removable or non-removable interface is typically used, such as interface 1226.

It is to be appreciated that FIG. 12 describes software that acts as an intermediary between users and computer resources described in suitable operating environment 1200. Such software includes an operating system 1228. Operating system 1228, which can be stored on disk storage 1224, acts to control and allocate resources of computer system 1212. System applications 1230 take advantage of the management of resources by operating system 1228 through program modules 1232 and program data 1234 stored either in system memory 1216 or on disk storage 1224. It is to be appreciated that the disclosed subject matter can be implemented with various operating systems or combinations of operating systems.

A user can enter commands, e.g., via UI component 510, or information into computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, cellular phone, user equipment, smartphone, and the like. These and other input devices connect to processing unit 1214 through system bus 1218 via interface port(s) 1238. Interface port(s) 1238 include, for example, a serial port, a parallel port, a game port, a universal serial bus (USB), a wireless based port, e.g., Wi-Fi, Bluetooth, etc. Output device(s) 1240 use some of the same type of ports as input device(s) 1236.

Thus, for example, a USB port can be used to provide input to computer 1212 and to output information from computer 1212 to an output device 1240. Output adapter 1242 is provided to illustrate that there are some output devices 1240, like display devices, light projection devices, monitors, speakers, and printers, among other output devices 1240, which use special adapters. Output adapters 1242 include, by way of illustration and not limitation, video and sound devices, cards, etc. that provide means of connection between output device 1240 and system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. Remote computer(s) 1244 can be a personal computer, a server, a router, a network PC, a workstation, a microprocessor based appliance, a peer device, or other common network node and the like, and typically includes many or all of the elements described relative to computer 1212.

For purposes of brevity, only a memory storage device 1246 is illustrated with remote computer(s) 1244. Remote computer(s) 1244 is logically connected to computer 1212 through a network interface 1248 and then physically and/or wirelessly connected via communication connection 1250. Network interface 1248 encompasses wire and/or wireless communication networks such as local-area networks (LAN) and wide-area networks (WAN). LAN technologies include fiber distributed data interface (FDDI), copper distributed data interface (CDDI), Ethernet, token ring and the like. WAN technologies include, but are not limited to, point-to-point links, circuit switching networks like integrated services digital networks (ISDN) and variations thereon, packet switching networks, and digital subscriber lines (DSL).

Communication connection(s) 1250 refer(s) to hardware/software employed to connect network interface 1248 to bus 1218. While communication connection 1250 is shown for illustrative clarity inside computer 1212, it can also be external to computer 1212. The hardware/software for connection to network interface 1248 can include, for example, internal and external technologies such as modems, including regular telephone grade modems, cable modems and DSL modems, wireless modems, ISDN adapters, and Ethernet cards.

The computer 1212 can operate in a networked environment using logical connections via wired and/or wireless communications to one or more remote computers, cellular based devices, user equipment, smartphones, or other computing devices, such as workstations, server computers, routers, personal computers, portable computers, microprocessor-based entertainment appliances, peer devices or other common network nodes, etc. The computer 1212 can connect to other devices/networks by way of antenna, port, network interface adaptor, wireless access point, modem, and/or the like.

The computer 1212 is operable to communicate with any wireless devices or entities operatively disposed in wireless communication, e.g., a printer, scanner, desktop and/or portable computer, portable data assistant, communications satellite, user equipment, cellular base device, smartphone, any piece of equipment or location associated with a wirelessly detectable tag (e.g., scanner, a kiosk, news stand, restroom), and telephone. This includes at least Wi-Fi and Bluetooth wireless technologies. Thus, the communication can be a predefined structure as with a conventional network or simply an ad hoc communication between at least two devices.

Wi-Fi allows connection to the Internet from a desired location (e.g., a vehicle, couch at home, a bed in a hotel room, or a conference room at work, etc.) without wires. Wi-Fi is a wireless technology similar to that used in a cell phone that enables such devices, e.g., mobile phones, computers, etc., to send and receive data indoors and out, anywhere within the range of a base station. Wi-Fi networks use radio technologies called IEEE 802.11 (a, b, g, etc.) to provide secure, reliable, fast wireless connectivity. A Wi-Fi network can be used to connect communication devices (e.g., mobile phones, computers, etc.) to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving, by a system comprising a processor, status information corresponding to a communication session of a communication device;
based on the status information, determining, by the system utilizing a rule representing a condition of the communication session, an action to be performed with respect to an emulation of a portion of the communication session; and
sending, by the system, an instruction representing the action directed to a proxy device for performance of the emulation of the portion of the communication session.

2. The method of claim 1, wherein the status information represents a state of the communication device.

3. The method of claim 2, wherein the state represents an amount of battery power determined for the communication device.

4. The method of claim 2, wherein the state represents an amount of processing determined to be performed by the communication device.

5. The method of claim 2, wherein the state represents a quality of a signal determined to have been received by the communication device.

6. The method of claim 1, wherein the status information represents a quality of a signal determined to have been received by a network device corresponding to the communication session.

7. The method of claim 1, further comprising:
based on the instruction, translating, by the system, the portion of the communication session to a substitute portion, wherein the substitute portion corresponds to a first communication bandwidth that is lower than a second communication bandwidth corresponding to the portion of the communication; and
sending, by the system via the proxy device, the substitute portion directed to the communication device.

8. The method of claim 1, further comprising:
based on the instruction, generating, by the system, a proxy communication corresponding to the portion of the communication session; and
sending, by the system via the proxy device, the proxy communication directed to a target communication device on behalf of the communication device.

9. The method of claim 1, further comprising:
based on the instruction, recording, by the system, the portion of the communication session.

10. The method of claim 1, further comprising:
in response to receiving a message comprising a request from a subscriber of a communication service corresponding to the communication session, determining, by the system, a requested action to be performed with respect to the portion of the communication session.

11. The method of claim 10, further comprising:
sending, by the system, request information representing the requested action directed to the proxy device for performance of the requested action.

12. A system, comprising:
a processor; and
a memory that stores executable instructions that, when executed by the processor, facilitate performance of operations, comprising:
determining status information associated with a communication session corresponding to a communication device;
based on the status information, determining, using a defined policy with respect to a condition associated with the communication session, an action to be performed with respect to an emulation of a portion of the communication session; and
sending instruction information representing the action directed to a proxy device for performance of the emulation of the portion of the communication session.

13. The system of claim 12, wherein the status information represents a state of the communication device.

14. The system of claim 12, wherein the status information represents a state of a network device corresponding to the communication session.

15. The system of claim 12, wherein the action comprises generation of a proxy communication corresponding to the portion of the communication.

16. The system of claim 12, wherein the action comprises storage of the portion of the communication in a storage device.

17. A computer-readable storage medium having stored thereon computer executable instructions that, in response to execution, cause a computing device including a processor to perform operations, the operations comprising:
determining status information corresponding to a communication associated with a communication device;
based on the status information, determining, using a defined set of rules with respect to a condition corresponding to the communication, an action to be performed with respect to an emulation of at least a portion of the communication; and
sending proxy information directed to a proxy device for performance of the emulation of at least the portion of the communication.

18. The computer-readable storage medium of claim 17, wherein the determining the status information comprises determining a device state of the communication device.

19. The computer-readable storage medium of claim 17, wherein the determining the status information comprises determining a device state of a network device corresponding to the communication.

20. The computer-readable storage medium of claim 17, wherein the operations further comprise:
generating, based on at least the portion of the communication, a message; and
sending, via the proxy device, the message directed to the communication device.
